(19) United States
(12) Patent Application Publication
(10) Pub. No.: US 2026/0364550 A1
(43) Pub. Date: Nov. 19, 2026

(54) MICROFLUIDIC SYSTEM THAT PROVIDES A SUSTAINABLE LIQUID MIXTURE WITH CONSTANT RATIOS WITH A SINGLE SYRINGE MOVEMENT

(71) Applicant: BOGAZICI UNIVERSITESI, Istanbul (TR)

(72) Inventor: Senol MUTLU, Uskudar, Istanbul (TR)

(21) Appl. No.: 19/143,188

(22) PCT Filed: Dec. 25, 2023
(86) PCT No.: PCT/TR2023/051675

§ 371 Date: Jun. 25, 2025

(30) Foreign Application Priority Data
Dec. 26, 2022 (TR) 2022/020411

(51) Int. Cl. B01F 33/30; B01F 25/433; B01F 35/21; B01F 35/71; B01F 35/75

(52) U.S. Cl. CPC B01F 33/30; B01F 25/4331; B01F 35/2132; B01F 35/7174; B01F 35/75465

(57) ABSTRACT

A microfluidic system that provides a sustainable liquid mixture with constant volumetric flow rates with a single syringe movement, without the need for any valves. The system allows for the continuous introduction and mixing of the desired number of reference liquids with the sample. In addition, pH measurement can be taken continuously with the microfluidic system.

### TECHNICAL FIELD OF THE INVENTION

The invention relates to a microfluidic system that provides a sustainable liquid mixture with constant volumetric flow rates with a single syringe movement, without the need for any valves. By means of the system that is the subject of the invention, the continuous introduction and mixing of the desired number of reference liquids is ensured. In addition, pH measurement can be taken continuously by means of the microfluidic system of the invention.

### STATE OF THE ART

Microfluidic systems are of great importance in said applications because they perform uniform and controllable liquid manipulation, biochemical reactions and their analysis in a low-cost and rapid way [1]. Microfluidic systems are used in clinical biology and chemistry, genetic analysis, capillary electrophoresis, DNA amplification, proteomics, cellular analysis, point-of-care testing (POC), drug discovery, and molecule and material syntheses [2].

Poly(dimethylsiloxane) (PDMS) and soft lithography-based microfluidics in the state of the art are now widely used for exploratory research in many laboratories. The reason why these microfluidics are widely used is that they are low cost, easy to use and can create integrated pneumatic valves. In addition, microfluidic chips made of thermoplastics such as poly(methyl methacrylate) (PMMA) [3], polystyrene (PS) [4] and cyclo-olefin polymer (COP) [5] are of great importance for commercial use because they can be mass produced. Glass microfluidic chips are preferred in applications requiring harsh conditions due to their resistance to chemicals and heat [6]. Although improvements have been made on these systems for nearly 30 years due to the increasing need for microfluidic systems, microfluidic systems still have limited use in clinical laboratories or industry where benchtop analytical instrumentation is used [2]. Microfluidic chips are produced with polydimethylsiloxane (PDMS), plastic or silicon materials and are small and low-profile. However, in order to carry out the protocols required in chemistry and biology, the entry and flow of liquids into these chips must be controlled and said liquids must be analysed within the chip at certain stages. For this, valves, pumps, and sensors that can work with chips are needed. Since these valves, pumps and sensors cannot be integrated with microfluidic chips at a level that will bring commercial success, they must remain outside the chip. Every valve, pump, and sensor outside has to be connected with high volume pipes. Therefore, the most important advantage of microfluidic chips, which is the usage of very low dead liquid volume and low liquid volumes for analysis becomes impossible. For these reasons, most existing solutions require manual intervention. Since such interventions are generally performed under large microscopes, with the help of large valves, pumps and analysis systems positioned around the microscope, the general use of these systems has been limited so far.

Most industrial and medical systems in the state of the art require continuous and automatic sampling and analysis of liquids. It is difficult to continuously sample liquid sources whose volume, pressure, or flow rates are unknown. Examples of such sources are a swimming pool, industrial processing tank, water pipe, different water levels of a lake, sea or ocean, and body fluids. Especially in some sources, samples need to be given continuously and said samples must be mixed at a constant rate, regardless of the pressure values of the samples. Microfluidic systems are needed to mix said samples at a constant rate. To give an example to understand the need for microfluidic systems more clearly, pH measurement will be a good guide. In ocean research, it is desired to observe the pH change in water by making locally sensitive pH measurements. So, ocean water does not have a single pH value. There are different local pH values in different regions. To map the pH of a particular ocean area, pH must be measured as the ship sails. In one study, measurements were made in this way for 3 months. Consumables are required for pH measurements. For these consumables to last for 3 months or to use less consumables, microfluidic chips are used. Continuous pH measurements in resources such as the ocean are only possible with the use of microfluidic systems. Therefore, today's developments in microfluidics have turned towards liquid pumping, flow control and mixing at constant and stable rates.

In the state of the art, intense research on liquid pumping, flow control, and mixing at constant and stable rates has resulted in many passive and active pumping methods. In the passive pumping approach, microfluidics are generally driven and operated without any external actuator, field or power source. These are osmosis, capillary action, surface tension and gravity-induced flow systems [7]. However, these systems are mostly intended for single-use applications and cannot be used in continuous industrial operations that typically last for months.

In active pumping, which is another pumping system used in microfluidic systems in the state of the art, peristaltic, recirculation, pressure-driven and flow rate-based methods are common. Peristaltic and recirculation pumps are easy to use but have strong pulses in their flow. Pressure-operated systems offer high performance and pulse-free flows with fast responses, but these systems are expensive and require an external pressure source. In addition, when strong pulses come from pumps to microfluidic channels, the speeds and mixing ratios of the liquids in the channel change uncontrollably. The measurements made in the analysed section are meaningless until the effects of these impacts wear off. After a pulse, it can take minutes for liquids to begin stably mixing again in their designed ratios.

Syringe pumps are the most commonly used devices in microfluidic systems to produce constant flow rates because they offer more stable flows than peristaltic or recirculation pumps. Syringe pumps consist of step motors, ball screws and gears. They are low cost and these pumps are easy to use and install. Additionally, syringe pumps are typically operated in open loop [8], causing flow rates and mixing ratios to depend on the characteristics of the pump and channel and the inlet pressure of the sample. Even the same type of syringe pumps from the same manufacturer can cause different flow characteristics in the microfluidic system [9]. Therefore, systems that use a single syringe pump action to produce the desired mixing ratio are desired. Precise and sustainable mixing rates can be achieved by using syringe pumps in closed-loop feedback control, incorporating multiple flow rate sensors and a controller as shown in FIG. 1a. However, said system is expensive and complex. Alternatively, a vacuum source in the form of a single syringe pump that draws liquids through the outlet port can be used to introduce the sample and reference liquids into the mixer of the microfluidic chip, as shown in FIG. 1b. However, in this case, the mixing ratios of the liquids change due to the differences in inlet pressure and hydraulic resistance [10].

In the state of the art, there are push-pull or infusion-withdrawal syringe pumps. In systems with these pumps, infusion and withdrawal are applied simultaneously through two different syringes connected to the same mechanical action, as shown in FIG. 2. A syringe is connected to the inlet of the canal or tissue and the plunger of the syringe is pushed to inject fluid into the canal or tissue. Another syringe connected to the outlet of the channel or tissue is withdrawn and thus the solution coming out of the channel or tissue can be collected directly [11]. This type of push-pull system provides pulse-free, high accuracy and high precision flow to bioreactor systems and can make the flow in the channel more stable [12]. Said system is widely used to inject solutions into living tissues such as brain tissue [13, 14]. Balance between the injected volume and the displaced volume is achieved by injecting the inlet fluid into the inlet and simultaneously collecting the displaced fluid from the outlet. Additionally, continuous perfusion of cell-laden solution into tissue scaffolds is also used to seed cells there [14]. In microfluidic systems, sample introduction methods are also performed using a switch valve based on pressure-dependent push-pull flow. The push-pull system is used to better define and control sample plug injections in cross, double-T, and multi-channel structures, and the performance of the system is relatively insensitive to chip geometry [15]. Moreover, said push-pull system is used in a low-cost and disposable laboratory cartridge in an automatic sample preparation system for disease diagnosis based on nucleic acids. Transport of the reagents is achieved by a combination of pushing and pulling forces (by compressed air and vacuum, respectively) connected to pneumatic inlets at the bottom of the cartridge. Pneumatic forces are regulated by the compression valve manifold and two pneumatic syringe pumps within the desktop unit [16]. As a result, in push-pull syringe pump systems, a single liquid is injected or sampled. Introducing a second inlet liquid and mixing at a constant volumetric ratio is not possible in these systems.

While a single liquid is injected or a single sample is taken in all microfluidic systems mentioned in the state of the art, introducing a second input liquid, and mixing it at a constant volumetric rate is not possible in these microfluidic systems. In addition, in the state of the art, more than one syringe pump with valves or the ability to move back and forth is used to introduce the sample into the system and mix it with another liquid.

Another area of use of microfluidic systems in the state of the art is pH measurement. One of the oldest ways to measure the pH of liquids is to use pH indicators. However, for continuous pH measurements, using commonly used paper-based pH indicators, in which small molecules are immobilised within the paper, is not practical as it requires manual manipulations or robotic movements. In addition, pH measurement is currently carried out with glass reference electrodes, which are fragile, difficult to maintain and take up a lot of space. These electrodes have a lifespan of 6 months to 1 year. For these reasons, its use in industrial conditions is not practical. Recently, measurements performed by taking continuous colorimetric measurements of pH using microfluidics have proven useful in ocean studies. Continuous measurement of ocean water pH was achieved with a thermoplastic microfluidic chip, two separate syringe pumps, multiple valves, and a thymol blue pH indicator. Automated benchtop spectrophotometer and LEDs were placed on board for colour measurements as shown in FIG. 3 [17]. In another study, spectrophotometric, sensitive, accurate and long-term measurements of seawater pH with an automatic device were also carried out using multiple pumps and valves [18]. Another ocean pH measurement similar to said study uses an integrated low-cost detection system, a light-emitting diode as the light source, and a photodiode as the detector instead of expensive spectrophotometers. Additionally, the study uses an automated reagent-based microfluidic pH sensor platform with a microfluidic chip, multiple pumps, valves, and electronic control to handle low volumes of samples and reagents. Different dye combinations have also been examined to allow a wider range of pH sensing than can be achieved using a single dye. The reagent was observed to remain stable for more than 8 months and a high reproducibility was reported [19]. Similarly, for marine pH measurement by colorimetry, a low-cost lab-on-a-chip device has been developed using a PDMS microfluidic system and an integrated low-cost optical-electronic system using light-emitting diodes as light sources and photodiodes as detectors. Two different syringe pumps, individually controlled by electronics, were used to pump the indicator solution, meta-Cresol Purple (mCP), and seawater. The device has a resolution of 0.002 pH units for the seawater pH range [20]. In another practical application, continuous photometric pH measurements were obtained in addition to detecting active chlorine and total chlorine concentrations of swimming pools. The sensor consists of a four-layer borosilicate glass chip controlled by multiple syringe pumps [21]. The fact that more than one syringe pump is used in pH measurements carried out with microfluidic systems in the state of the art is one of the shortcomings of the state of the art.

Due to reasons such as limitations and inadequacies of microfluidic systems in the state of the art, microfluidic systems in the state of the art having limited use in clinical laboratories or industry where benchtop analytical instrumentation is used, and in addition, these systems being insufficient for liquid pumping, flow control and mixing at constant and stable rates, microfluidic systems in the state of the art being mostly for single-use applications and these systems being impossible to use in any industrial operation that may last a long time, peristaltic and circulation pumps that provide active pumping and are used in microfluidic systems in the state of the art creating strong pulses, and systems that provide active pumping and work with pressure being costly and requiring an external pressure source, syringe pump systems in the state of the art, which are preferred in microfluidic systems to produce constant flow rates because they offer more stable flows than peristaltic or recirculation pumps, requiring valves or more than one syringe pump with the ability to move back and forth to introduce the sample into the system and mix it with another liquid, and the inability to introduce a second inlet fluid and ensure mixing at a constant volumetric ratio in push-pull syringe pump systems, it has been necessary to develop a microfluidic system that eliminates all these problems, enables continuous introduction and mixing of the desired number of reference liquids, and provides liquid pumping, flow control and mixing at constant and stable rates.

### BRIEF DESCRIPTION AND AIMS OF THE INVENTION

In the invention, a microfluidic system that provides a sustainable liquid mixture with constant volumetric flow rates with a single syringe movement, without the need for any valves, is explained. Sustainable mixing of two liquids at constant volumetric flow rates means that they always mix at the same volumetric flow rate. By means of the system that is the subject of the invention, the continuous introduction and mixing of the desired number of reference liquids is ensured. In addition, pH measurement can be taken continuously by means of the microfluidic system of the invention. The fixed rates provided by the microfluidic system of the invention depend only on the diameters of the syringes connected externally, regardless of the hydraulic resistances of the microfluidic chip and the inlet pressure values of the sample. In the microfluidic system of the invention, samples can be taken continuously from the target liquid and the taken liquid is mixed with other liquids at a constant mixing ratio using unidirectional mechanical motion.

In the system that is the subject of the invention, the need for the sample to be inside a syringe is eliminated. It can be at different water heights and open to air. Additionally, since the mixed solution is collected by the pull syringe, it does not contaminate the sample or the environment. In current systems, the liquid to be measured is first pulled into the syringe and then pushed into the microfluidic chip with the help of a valve. In the system that is the subject of the invention, the liquid to be measured can be dropped into the inlet port of the chip. With the system that is the subject of the invention, the dripped liquid is automatically pulled into the chip and mixed with the other liquid. The liquid to be measured can also be fed into the system by dipping the chip into the liquid. In this case, different pressure values occur at the inlet port of the chip depending on the depth of the liquid. By means of the system of the invention, liquid is pulled into the chip in the same way and mixed with other liquid in the same way, regardless of these different pressure values.

An aim of the invention is to provide a sustainable liquid mixture with constant proportions in microfluidic systems with a single syringe movement, without the need for any valves. In the system that is the subject of the invention, ensuring a sustainable liquid mixture with constant proportions with a single syringe stroke, without the need for any valves is achieved by a single syringe pump action, where one syringe sucks from the microfluidic chip with a certain volumetric flow rate and the other syringe pushes the reference liquid into the chip with a different volumetric flow rate. While a single liquid can be injected or sampled in all push-pull syringe pump methods in the state of the art, in the system of the invention, a sample solution is continuously introduced and mixing with a reference solution at a constant and sustainable volumetric ratio is made possible. In addition, to achieve this, the use of a single syringe pump without a valve is sufficient in the system of the invention.

Another aim of the invention is to provide a microfluidic system for use in clinical laboratories or industry where benchtop analytical instrumentation is used. In the invention, a microfluidic system used in clinical laboratories or industry where bench-top analytical instrumentation is used is provided by a microfluidic chip, which has parts that allow the injected reference liquid to be mixed with the liquid to be measured that is automatically drawn into another inlet channel, and that allow the analysis of the mixture.

In the invention, a microfluidic system is provided in which the desired number of reference liquids can be continuously introduced and mixed. A microfluidic system in which the desired number of reference liquids can be continuously introduced and mixed is provided by the addition of more syringes to the same mechanical movement of the syringe pump in the microfluidic system of the invention, the appropriate adjustment of the cross-sectional areas of these syringes, and the microfluidic chip suitable for the mixing and analysis of multiple liquids. In the system that is the subject of the invention, there is no mixing limit with a single reference liquid. By expanding the system that is the subject of the invention, the sample can be continuously introduced into the system and mixed with the desired amount of reference liquid.

Another aim of the invention is to provide a microfluidic system that is fully effective in liquid pumping, flow control and mixing at constant and stable rates. In the invention, providing a microfluidic system that is fully effective in liquid pumping, flow control and mixing at constant and stable rates is achieved by having different cross-sectional areas of push and pull syringes that are connected to the system externally and connected to the same mechanical action of the same syringe pump.

Another aim of the invention is to provide a microfluidic system that is not disposable but has a long-term use. Providing a microfluidic system for long-term use is achieved in the invention by allowing the microfluidic chip to consume low amounts of liquid volumes and externally connected syringes to hold high volumes of liquid.

In the invention, a microfluidic system in which the need for an external pressure source is eliminated is provided. Elimination of the need for an external pressure source is achieved in the microfluidic system of the invention by the push syringe connected to the system externally and connected to the same mechanical action of the same syringe pump injecting the liquid into the microfluidic chip with a certain liquid volume flow rate and the pull syringe pulling it with a different liquid volume flow rate.

Another aim of the invention is to provide a microfluidic system that eliminates the need for expensive and complex syringe pump systems. The need for expensive and complex syringe pump systems is eliminated in the microfluidic system of the invention, as it does not require any valves or second or more syringe pumps.

The invention provides a microfluidic system that eliminates the need for valves or multiple bidirectional syringe pumps. Providing a microfluidic system that eliminates the need for valves or multiple bidirectional syringe pumps is provided in the microfluidic system that is the subject of the invention, by injecting the reference liquid into the microfluidic chip with a certain liquid volume flow rate by the push syringe, which is externally connected to the system and connected to the same mechanical movement of the same syringe pump, and pulling the liquid to be measured to the chip by the difference in volumetric flow rates of fixed syringes as a result of the pull syringe pulling the liquid mixed with a different liquid volume flow rate.

### DESCRIPTION OF DRAWINGS

FIG. 1. As two common systems of the prior art for introducing liquids with desired volumetric proportions for mixing: A. a system used in conjunction with pumps, flow rate sensors, and a controller with closed-loop feedback. B. a system using a single syringe pump.

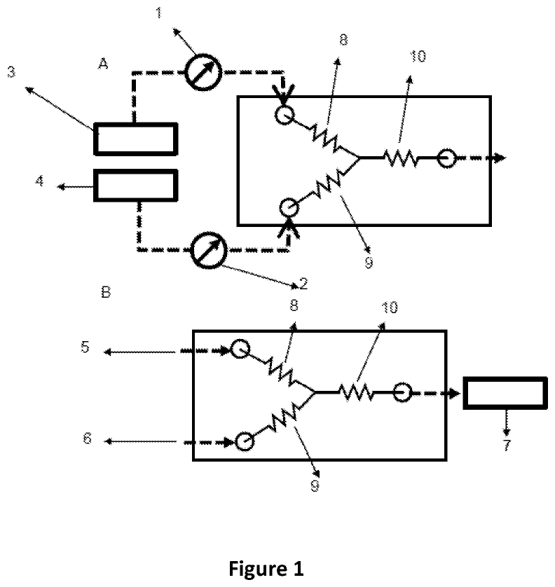

FIG. 2. As examples of prior art push-pull (infusion-withdrawal) syringe systems: A. a syringe pump that pushes the nutrient medium into a bioreactor while pulling outflow from the outlet port [11], B. a syringe connected to the channel inlet that pushes the solution with cells into the channel, another syringe connected to the channel outlet that pulls the solution out of the channel [12].

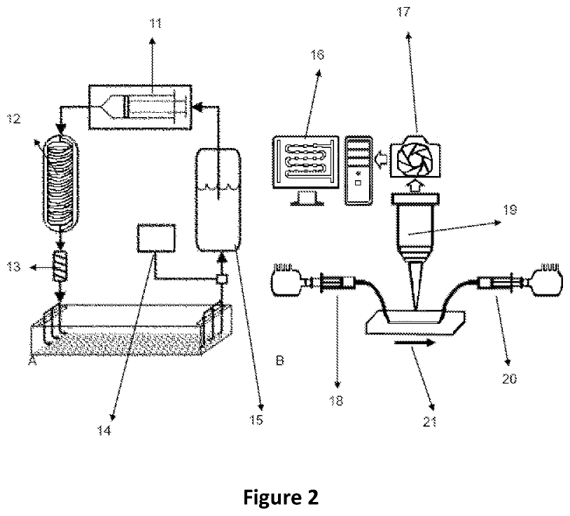

FIG. 3. An example of continuous colorimetric pH measurements using the state of the art microfluidic chip and multiple syringe pumps and valves. [17].

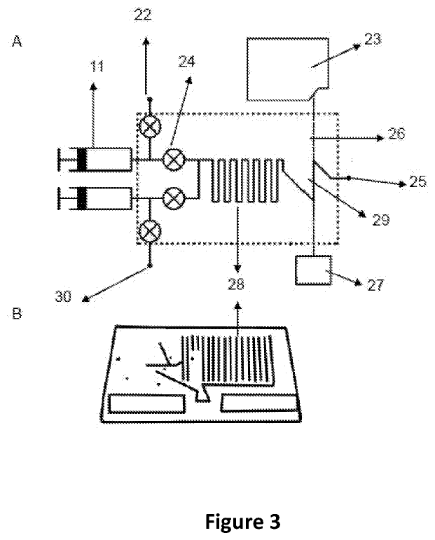

FIG. 4. The microfluidic system that is the subject of the invention, providing a sustainable liquid mixture at fixed rates with a single syringe movement, without the need for any valve.

FIG. 5. The electrical equivalent circuit of the microfluidic system that is the subject of the invention, providing a sustainable liquid mixture at fixed rates with a single syringe movement, without the need for any valve.

FIG. 6. The use of the system that is the subject of the invention in the continuous measurement of pH by colorimetric method in the presence of a microfluidic chip.

FIG. 7. Experimental demonstration of the system that is the subject to the invention, with the help of a Y-channel microfluidic chip, that the sampled liquid and the reference liquid can be mixed sustainably in the desired proportions by simply changing the cross-sectional areas of the syringes attached externally. A. Experimental demonstration of the case where the mixing ratio, the ratio of the cross-sectional area of syringe A1 to the cross-sectional area of syringe A2, in the microfluidic chip is 0.52. The widths of the liquids created in the channel gives the volumetric mixing ratio. B. The case where the cross-section ratio is 0.36. C. The case where the cross-section ratio is 0.25. D. The case where the cross-section ratio is 0.1. E. Demonstration of connecting the Y-channel microfluidic chip to the syringe pump and push-pull syringes.

FIG. 8. Graphic plotting of the experiment shown in FIG. 7, according to the ratio of the width ratios of the liquids in the channel to the cross-sectional areas of the syringes.

FIG. 9. A. Microfluidic chip structure that provides pH measurement in the system that is the subject of the invention and consists of a Y channel, a mixer, an observation window and an output port. B. Experimental demonstration of the mixing performance of the chip by showing photographs of the mixing state of two liquids at three different points near the inlet of the chip for a volumetric flow rate of 1 mL/h. C. Demonstration for a volumetric flow rate of 5 mL/hour. D. Demonstration for a volumetric flow rate of 10 mL/hour. E. Demonstration for a volumetric flow rate of 20 mL/hour.

FIG. 10. Demonstration of the experimental results presented in FIG. 6 obtained using the red pH indicator in the system that is the subject of the invention, with absorbance measurements obtained from multiple wavelengths of the colour sensor

FIG. 11. Presentation of the absorbance measurement results in FIG. 10 in a different format to show the pH value. Plot of the natural logarithm of absorbance ratios at 550 and 450 nanometre (nm) wavelengths against pH values.

FIG. 12. Experimental results of pH measurement in the system of the invention using a universal indicator consisting of thymol blue, methyl red, bromothymol blue and phenolphthalein.

FIG. 13. Extending the microfluidic system of the invention to differential colour measurements in order to prevent measurements from being affected by non-ideal properties such as different colours, ions, ionic strengths, and temperatures of sample solutions.

FIG. 14. Expanding the system of the invention to be mixed with many different liquids and by using many different measurement or analysis methods.

### DEFINITION OF ELEMENTS/PARTS COMPOSING THE INVENTION

1. Prior art sensor 1
2. Prior art sensor 2
3. Prior art pump 1
4. Prior art pump 2
5. Prior art sample fluid
6. Prior art reference fluid
7. Prior art vacuum
8. Hydraulic resistance at the first inlet of the microfluidic chip
9. Hydraulic resistance at the second inlet of the microfluidic chip
10. Hydraulic resistance at the outlet of the microfluidic chip
11. A prior art syringe pump
12. Prior art gas exchanger (O₂/N₂)
13. Prior art bubble trap
14. Prior art oxygen (O₂) probe
15. Prior art culture medium
16. Prior art visual processing computer
17. Prior art high speed camera
18. Prior art syringe pump through which the sample is pushed
19. Prior art microscope
20. Prior art pull syringe pump
21. Prior art flow direction
22. Prior art sample inlet
23. Prior art spectrometer
24. Prior art valve
25. Prior art waste outlet
26. Prior art fibre optic
27. Prior art LEDs
28. Prior art static mixer
29. Prior art absorbance cell
30. Prior art indicator inlet
31. Mechanical connection of syringes
32. Q2 flow rate
33. Q1 flow rate
34. Mechanical motion
35. Syringe A1
36. Syringe A2
37. Fixed body
38. Output port
39. Sample liquid at atmospheric pressure Pₒ plus pressure Pₛ, which may be due to the height of the liquid
40. Other inlet of the microfluidic system
41. Microfluidic chip
42. Trapped waste
43. Hydraulic resistance between syringe and microfluidic chip
44. Cross-sectional area of syringe A1, A₁
45. Cross-sectional area of syringe A2, A₂
46. Volumetric flow rate equal to the difference Q₂−Q₁
47. Internal hydraulic equivalent resistance to Syringe A1
48. Internal hydraulic equivalent resistance to Syringe A2
49. Hydraulic resistance seen at the sample inlet
50. Mixer
51. LED light source
52. Colour sensor
53. Observation window
54. The channel width of a liquid in the Y channel, W₁
55. The channel width of another liquid in the Y channel, W₃
56. Thymol blue
57. Methyl red
58. Bromothymol blue
59. Phenolphthalein
60. Analysis/measurement area
61. Volumetric flow rate of various reference chemicals
62. Required volumetric flow rate for drawing direction according to the desired mixing ratios
63. Inlet volumetric flow rate of the sample adjusted by the volumetric flow rates of the syringes used
64. Microfluidic chip used in pH measurement

### DETAILED DESCRIPTION OF THE INVENTION

The invention relates to a microfluidic system that provides a liquid mixture with constant and sustainable volumetric ratios with a single syringe pump action (34) without the need for any valve. Sustainable mixing of two liquids at constant volumetric flow rates means that they always mix at the same volumetric flow rate. By means of the system of the invention, the volumetric flow rates (61) of the desired number of different reference chemicals are continuously introduced and mixed. In addition, pH measurement can be taken continuously by means of the microfluidic system of the invention. The fixed volumetric rates provided by the microfluidic system of the invention depend only on the diameters of the syringes connected externally, regardless of the hydraulic resistances of the microfluidic chip (41) and the inlet pressure values of the sample. In the microfluidic system of the invention, samples can be taken continuously from the target liquid and the taken liquid is mixed with other liquids at a constant mixing ratio using unidirectional mechanical motion (34).

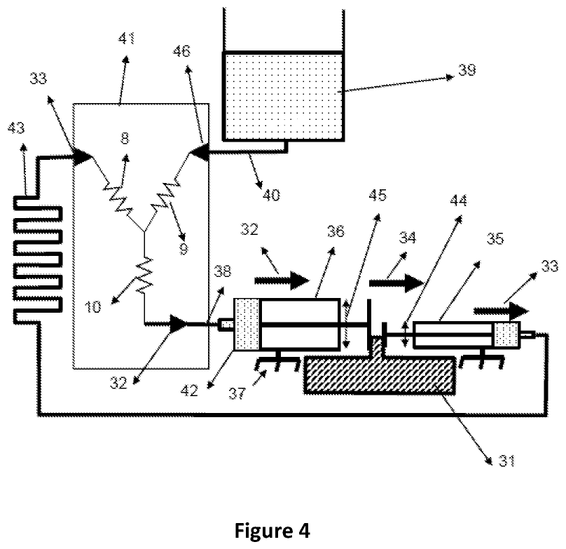

The microfluidic system that is the subject of the invention, providing a sustainable liquid mixture at fixed rates with a single syringe movement, without the need for any valve, is shown in FIG. 4. The mechanical action (34) of a single syringe pump is connected to two syringes with different cross-sectional areas (syringe A1 (35) and syringe A2 (36)) (can be any diameter value; for example, the largest practical diameter that can be used is 100-300 mm) as shown in FIG. 4. The cross-sectional areas of these syringes can be considered A1 and A2. The smaller syringe is used to pump or push the reference fluid into the microfluidic system at a constant volumetric flow rate Q1 (33) (pumping). However, the larger syringe (syringe A2 (36)) is also connected to the same mechanical action (34) in vacuum or pull mode and pulls liquids (mixed state of all liquids given to the system) from the outlet port (38) of the microfluidic chip (41) with a constant Q2 flow rate (32) (volumetric flow rate-suction). Said volumetric flow rates depend on the ratio of A1 and A2. The other inlet of the microfluidic system (40) is not connected to any syringe pump. This inlet can be immersed in a water tank, swimming pool, lake, or sea, connected to the sample via a microfluidic tube, or samples can be dropped onto it. Regardless of the inlet pressure of the fluid and the hydraulic resistances, the volumetric flow rate of introducing the sample into the microfluidic chip (41) through this inlet will be (Q2−Q1), since this flow rate depends only on the diameters of the externally connected syringes. Volumetric mixing ratios are adjusted by changing the cross-sectional areas of the syringes ((Q2−Q1)/Q1). This mixing ratio is precise and sustainable because it is produced by a single mechanical action (34). The mechanical action of the syringe pump (34) may vary slightly due to non-ideal reasons and the microfluidic paths may have different hydraulic resistances. However, by means of said system and its method of application, the volumetric mixing ratio always remains the same, depending on the cross-sectional area of the external syringes.

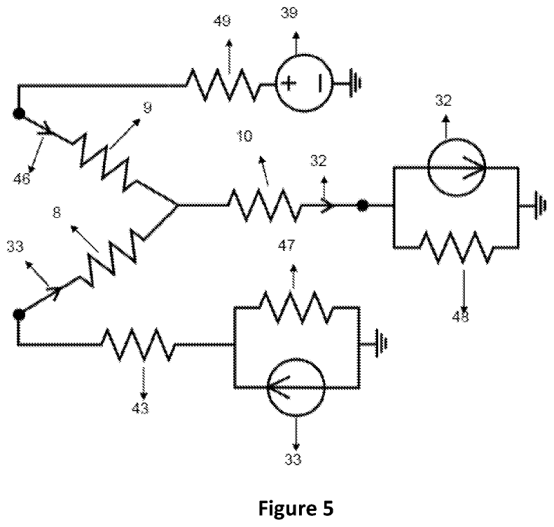

The electrical equivalent circuit of the microfluidic system that is the subject of the invention, providing a sustainable liquid mixture at fixed rates with a single syringe movement, without the need for any valve, is shown in FIG. 5. The implementation of the system that is the subject of the invention is explained by its electrical equivalent circuit as shown in FIG. 5. The flow rate Q1 (33) and flow rate Q2 (32) current sources determine the current flowing at the inlet of the sample, independent of the resistors and input voltage. Ideally, the internal resistance of the current sources should be infinite, so the flow Q1 (volumetric flow) of the syringe pump can be injected into the microfluidic chip (41) without loss. However, a syringe pump must be able to produce very high-pressure values in order to provide the required volumetric flow rate to the high value loads to which it is connected. In real life, pumps may not be able to produce the required high-pressure values and may have problems maintaining the required volumetric flow rate. To model such situations, a finite resistance value is connected in parallel to the current supply in the equivalent circuit model. Since this model resistance value will be much larger than the hydraulic resistances of the connecting elements and microfluidic chips for the volumetric flow rates used in practice, it can be assumed that the volumetric flows produced in the pump are transmitted to the microfluidic chip without loss.

While in all push-pull syringe pump methods in the state of the art, a single liquid can be injected or sampled, in the system of the invention, a sample solution is continuously presented and mixing with a reference solution at a constant and sustainable volumetric ratio is made possible. In addition, to achieve this, the use of a single syringe pump without a valve is sufficient in the system of the invention.

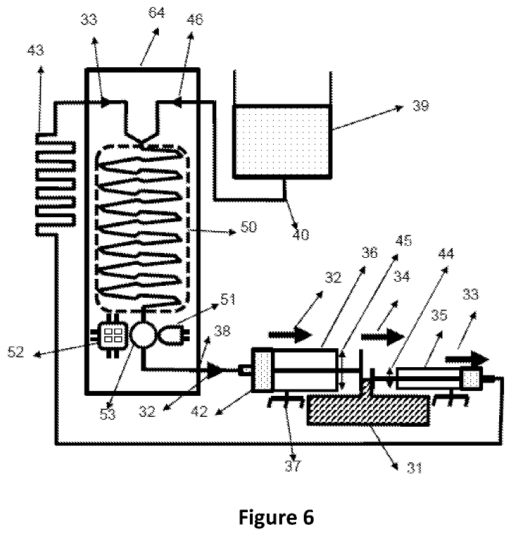

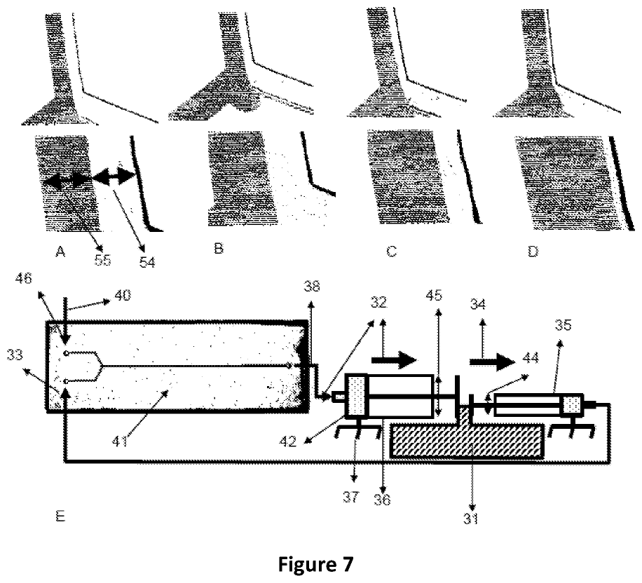

The system that is the subject of the invention is used for continuous colorimetric measurement of pH in the presence of the microfluidic chip (64) used in pH measurement. FIG. 6 shows the system of the invention adapted to be used in continuous colorimetric measurement of pH in the presence of the microfluidic chip (64) used in pH measurement. The method is first tested to see whether the liquids mix in defined proportions and maintain those proportions. For this, a Y microfluidic channel is produced using PMMA substrates. External connections are established using a single syringe pump with two syringes, as shown in FIG. 7. The push syringe with a diameter of 9.08 mm and a volume of 2.5 mL is kept stationary during measurements and pull syringes of different sizes are connected to the mechanical movement (34). The diameters of the pull syringes vary as 29, 18.2, 15.25 and 12.6 mm. In a Y microfluidic channel, due to laminar flow, two different liquids with different colours (scanned and unscanned regions within the channel) do not mix at the intersection. They form different flow sections of different widths (elements 54 and 55). These widths are directly proportional to volumetric flow rates. For this reason, by measuring the widths of different liquids inside the Y channel, the flow rates of the two liquids sent into the chip are determined. Images of the separated blue (unshaded region) and red (shaded region) flows for different externally connected withdrawal syringes are shown in FIG. 7. Experimental results of the new method show that volumetric mixing occur at defined rates and these rates are maintained. External connections are made to the Y-shaped microfluidic channel using a single syringe pump and two syringes. The push syringe is 9.08 mm in diameter. Different sizes of pull syringes are connected with diameters of 29, 18.2, 15.25 and 12.6 mm. The widths of the liquids flowing in the channel are measured as shown in FIG. 7 (elements 54 and 55).
2.5 mL vs. 5 ml syringe A1/A2=0.52 (Here A1 indicates the cross-sectional area of the 2.5 ml syringe and A2 indicates the cross-sectional area of the 5 ml syringe.)
2.5 mL vs. 10 ml syringe A1/A2=0.36
2.5 mL vs. 20 ml syringe A1/A2=0.25
2.5 mL vs. 50 ml syringe A1/A2=0.1

$$\frac{{W}_{1}}{{W}_{3}} = \frac{{Q}_{1}}{{Q}_{3}} = \frac{{Q}_{1}}{{Q}_{2} - {Q}_{1}} = \frac{{A}_{1}}{{A}_{2} - {A}_{1}} \qquad Formula 1$$

In Formula 1.
Q₁: is the volumetric flow rate of the liquid that the A1 syringe pushes into the microfluidic chip (41).
Q₂: is the volumetric flow rate of the liquid pulled by the A2 syringe from the outlet port (38) of the microfluidic chip (41).
Q₃: is the volumetric flow rate of the second liquid automatically sucked from the other inlet of the microfluidic chip (41). W₁ is the width created in the Y channel by the liquid entering with the flow Q₁ (width of a liquid in the Y channel, W₁ (54)). W₃ is the width formed by the liquid automatically sucked from the second inlet of the microfluidic chip (41) (the width of the other liquid in the Y channel, W₃ (55)).

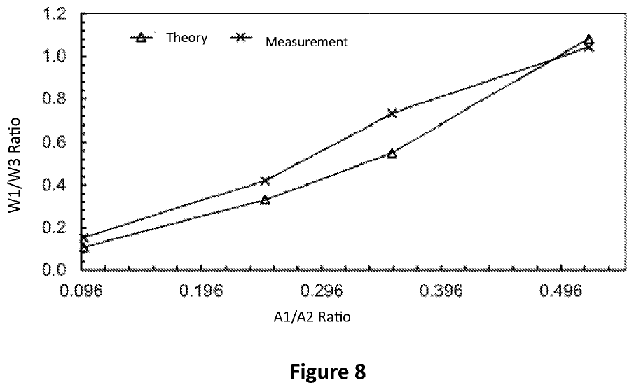

The measurement results of the experiment shown in FIG. 7 are presented graphically in FIG. 8. Here, the width ratios of the liquids in the channel are drawn according to the ratios of the cross-sectional areas of the syringes. These results show that the system of the invention can mix liquids in defined volumetric ratios and maintain these ratios. Sustainable mixing ratio means always providing the same ratio of mixture.

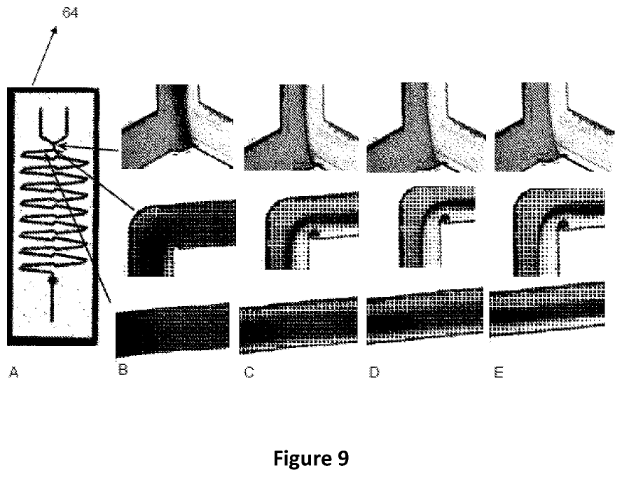

The microfluidic chip (64) used in pH measurement is shown in FIG. 9. The microfluidic chip (64) used in said pH measurement, consists of a Y channel to combine the sample and pH indicator, a mixer (50), an observation window (53) for the light coming from the LED light source (51) to pass and be collected by the multi-wavelength colour sensor (52) and an output port (38). In order to test the mixing functionality of the microfluidic chip (64) used in pH measurement, blue (left area in the channel) and red (right area in the channel) dyed liquids are introduced at different flow rates with the new method and it is observed whether complete mixing is achieved. Mixing begins at the intersection of the liquids (middle of the channel) and gradually spreads over the entire width of the channel. As the flow rates in the channel increase, complete mixing occurs in more distant regions of the mixer (50). As can be seen from FIG. 9, proper mixing is provided by the microfluidic chip (64) used in said pH measurement.

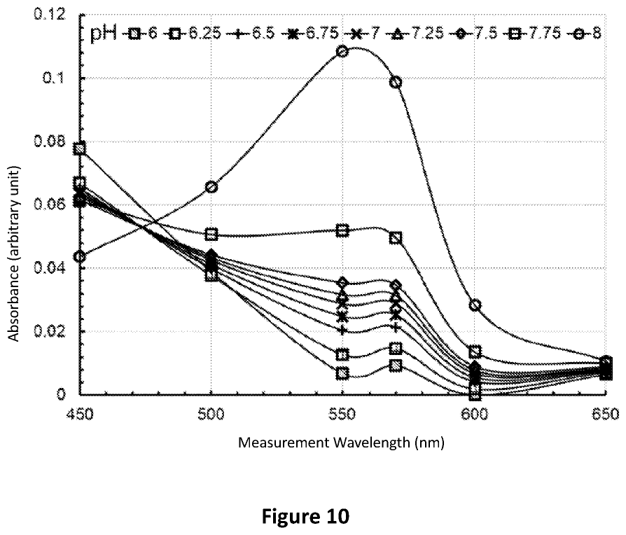

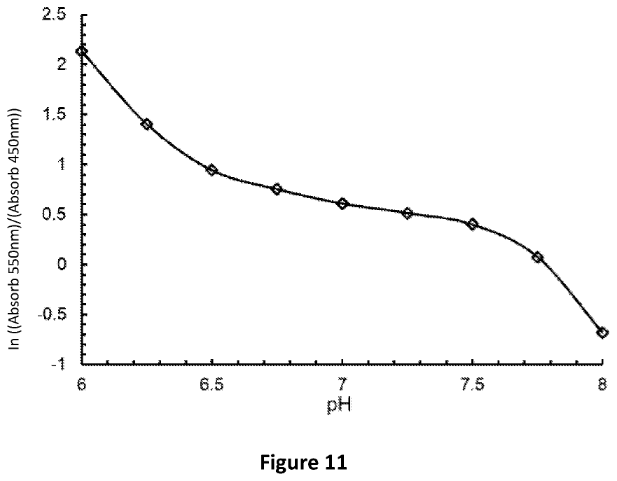

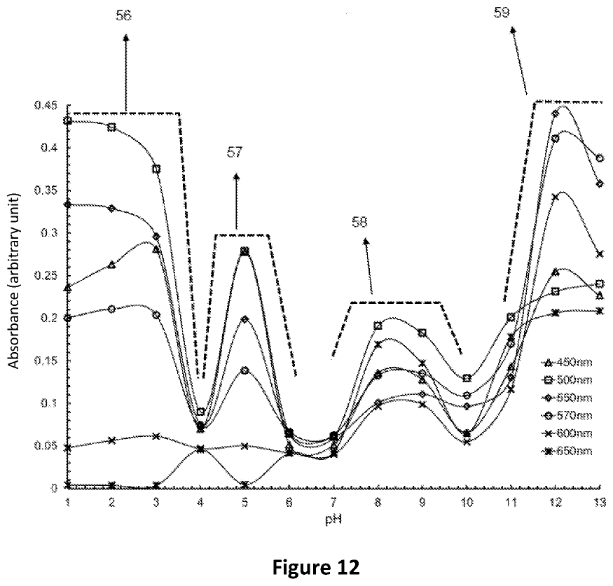

FIG. 10 shows multi-wavelength absorbance measurements detected by the colour sensor (52) for the red pH indicator. The results show the accuracy of the pH measurements made. The isosbestic point of this pH indicator is discerned from multiwavelength absorbance measurement (e.g., 450, 500, 550, 570, 600, and 650 nanometres (nm)) of pH changes between 6 and 8. Phenol red has peak responses at wavelengths of 557 and 433 nm. The natural logarithms of the absorbance ratios at 550 and 450 nm, close to said wavelengths, are shown in FIG. 11. It is seen that the calculated values coincide with the pH values to be measured. Phenol red has a limited pH measuring range. This range can be expanded by using different indicators. A universal pH indicator solution consisting of thymol blue (56), methyl red (57), bromothymol blue (58), and phenolphthalein (59) can be used to measure the pH range from 1 to 14. FIG. 12 shows the experimental results made with the system of the invention in which the universal indicator consisting of thymol blue (56), methyl red (57), bromothymol blue (58) and phenolphthalein (59) was used. The results clearly show the pH range in which each pH indicator is effective. These regions are marked in the chart. 4 different pH indicators are used in the experiment. Each pH indicator has a pH range in which it is effective. From the measurement results, it is clearly visible which pH indicator is active in which pH range. As a result, the system of the invention is successful in measuring pH continuously and accurately. Said effect is achieved by automatically adding the sample to the system and mixing it with a single reference solution at a predefined mixing ratio.

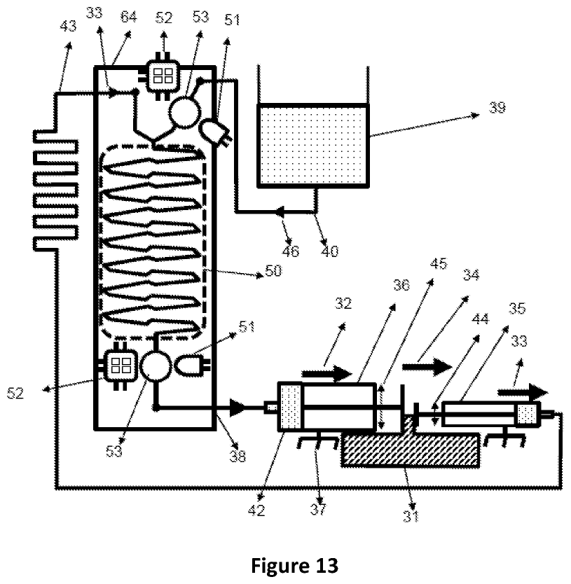

The performance of indicator-based sensors can produce errors because they are affected by ionic strength, temperature and mixtures of organic solvents [22]. The increase in ionic strength (IS) from 0.01 to 3 M can cause a strong increasing effect of some pH indicators such as bromophenol blue and a decreasing effect of pH indicators such as phenol red in the measurements. Some indicators, such as bromocresol green and methyl red, have a smaller effect. The performance of the sensor may decrease further if the given sample is not transparent and has a certain colour and light absorbance. This problem is solved with the system of the invention by making differential measurements as shown in FIG. 13. An additional observation window (53), an LED light source (51), and a colour sensor (52) are used in the inlet channel of the sample before mixing to take reference colour measurements. These are then compared with the results of the mixed sample with the pH indicator recorded from the other colour sensor (52). In this way, the dependence of pH measurement on any external factors is eliminated. Additionally, this system is not limited to just colour sensors (52). The sensor types in the observation windows (53) can be used with other detection methods by changing the selected sensors (electrochemical, electrical impedance type, piezoelectric, resistive, capacitive, inductive, mechanical, electromagnetic, optical, thermal and magnetic sensor, etc.).

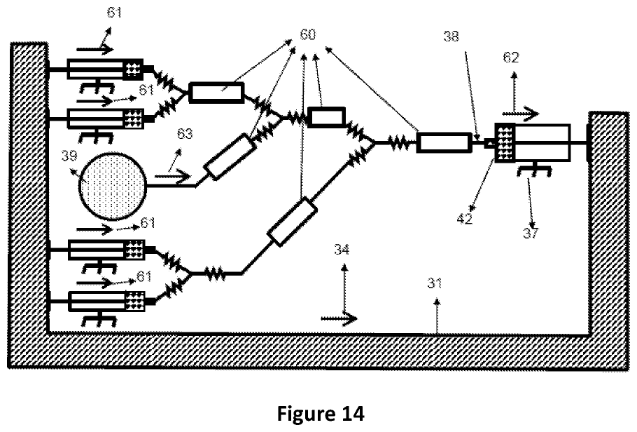

In the system that is the subject of the invention, there is no mixing limit with a single reference liquid. The sample liquid (39) at Po atmospheric pressure plus Ps pressure, which may be due to the height of the liquid, can be continuously introduced into the system and mixed with the volumetric flow rate (61) of the desired quantity of different reference chemicals, by expanding the system that is the subject of the invention, as shown in FIG. 14. In FIG. 14, mixing of five volumetric flow rates is shown as just one example. With proper design of mixing channels, the sample is first measured and analysed and then mixed with a specific chemical and measured and analysed again. This mixture can then be mixed with the desired amount of another chemical and measured and analysed. The values of the sample can be found from the difference between measurements and analysis.

Application method of a microfluidic system providing liquid mixing with constant volumetric flow rates, comprising the process step of:
i. combining the volumetric flow rate (61) of various reference chemicals with the inlet flow rate (63) of the sample adjusted by the flow rates of the syringes used, and then taking measurements in the analysis/measurement areas (60) and evaluating the measurements taken to find the physical, chemical or biological property desired to be measured in the sample.

Application method of a microfluidic system providing liquid mixing with constant volumetric flow rates and pH measurement, comprising the process step of:
i. measuring the pH value as a result of mixing with the pH indicator by performing differential colorimetric measurement, in order to prevent the sample solutions from being affected by non-ideal properties such as different colours, ions, ionic strengths and temperatures and finding the pH value by evaluating the absorbance measurements taken from the observation windows (53) before and after mixing the sample with the pH indicator.

### REFERENCES

[1] G. M. Whitesides, “The origins and the future of microfluidics,” nature, vol. 442, no. 7101, pp. 368-373, 2006.
[2] D. T. Chiu et al., “Small but perfectly formed? Successes, challenges, and opportunities for microfluidics in the chemical and biological sciences,” Chem, vol. 2, no. 2, pp. 201-223, 2017.
[3] E. Gencturk, K. O. Ulgen, and S. Mutlu, “Thermoplastic microfluidic bioreactors with integrated electrodes to study tumor treating fields on yeast cells,” Biomicrofluidics, vol. 14, no. 3, p. 034104, 2020.
[4] I. E. Odabasi, E. Gencturk, S. Puza, S. Mutlu, and K. O. Ulgen, “A low cost PS based microfluidic platform to investigate cell cycle towards developing a therapeutic strategy for cancer,” Biomedical Microdevices, vol. 20, no. 3, pp. 1-13, 2018.
[5] E. Gencturk, E. Yurdakul, A. Y. Celik, S. Mutlu, and K. O. Ulgen, “Cell trapping microfluidic chip made of Cyclo olefin polymer enabling two concurrent cell biology experiments with long term durability,” Biomedical Microdevices, vol. 22, no. 1, pp. 1-12, 2020.
[6] J. B. Nielsen, R. L. Hanson, H. M. Almughamsi, C. Pang, T. R. Fish, and A. T. Woolley, “Microfluidics: innovations in materials and their fabrication and functionalization,” Analytical chemistry, vol. 92, no. 1, pp. 150-168, 2019.
[7] V. Narayanamurthy et al., “Advances in passively driven microfluidics and lab-on-chip devices: a comprehensive literature review and patent analysis,” RSC Advances, vol. 10, no. 20, pp. 11652-11680, 2020.
[8] J. R. Lake, K. C. Heyde, and W. C. Ruder, “Low-cost feedback-controlled syringe pressure pumps for microfluidics applications,” PLoS One, vol. 12, no. 4, p. e0175089, 2017.
[9] H. Kim, D. Cheon, J. Lim, and K. Nam, “Robust Flow Control of a Syringe Pump Based on Dual-Loop Disturbance Observers,” IEEE Access, vol. 7, pp. 135427-135438, 2019.
[10] Y. Zhai, A. Wang, D. Koh, P. Schneider, and K. W. Oh, “A robust, portable and backflow-free micromixing device based on both capillary- and vacuum-driven flows,” Lab on a Chip, vol. 18, no. 2, pp. 276-284, 2018.
[11] J. W. Allen and S. N. Bhatia, “Formation of steady-state oxygen gradients in vitro: Application to liver zonation,” Biotechnology and bioengineering, vol. 82, no. 3, pp. 253-262, 2003.
[12] P. Li et al., “Microfluidic Device for Analyzing Self-adaption of Cancer Cell During Squeezing in channel,” in 2018 IEEE International Conference on Cyborg and Bionic Systems (CBS), 2018: IEEE, pp. 88-92.
[13] T. R. Slaney et al., “Push-pull perfusion sampling with segmented flow for high temporal and spatial resolution in vivo chemical monitoring,” Analytical chemistry, vol. 83, no. 13, pp. 5207-5213, 2011.
[14] M. Radisic, M. Euloth, L. Yang, R. Langer, L. E. Freed, and G. Vunjak-Novakovic, “High-density seeding of myocyte cells for cardiac tissue engineering,” Biotechnology and bioengineering, vol. 82, no. 4, pp. 403-414, 2003.
[15] Z. Wu, H. Jensen, J. Gamby, X. Bai, and H. H. Girault, “A flexible sample introduction method for polymer microfluidic chips using a push/pull pressure pump,” Lab on a Chip, vol. 4, no. 5, pp. 512-515, 2004.
[16] G. Xu et al., “A self-contained polymeric cartridge for automated biological sample preparation,” Biomicrofluidics, vol. 5, no. 3, p. 034107, 2011.
[17] V. M. Rérolle, C. F. Floquet, A. J. Harris, M. C. Mowlem, R. R. Bellerby, and E. P. Achterberg, “Development of a colorimetric microfluidic pH sensor for autonomous seawater measurements,” Analytica chimica acta, vol. 786, pp. 124-131, 2013.
[18] L. Cao et al., “Spectrophotometric loop flow analyzer for high-precision measurement of seawater pH,” Talanta, vol. 224, p. 121775, 2021.
[19] I. M. P. de Vargas Sansalvador, C. D. Fay, J. Cleary, A. M. Nightingale, M. C. Mowlem, and D. Diamond, “Autonomous reagent-based microfluidic pH sensor platform,” Sensors and Actuators B: Chemical, vol. 225, pp. 369-376, 2016.
[20] V. Pinto, C. Araújo, P. Sousa, L. Gonçalves, and G. Minas, “A low-cost lab-on-a-chip device for marine pH quantification by colorimetry,” Sensors and Actuators B: Chemical, vol. 290, pp. 285-292, 2019.
[21] S. Elmas et al., “Photometric sensing of active chlorine, total chlorine, and pH on a microfluidic chip for online swimming pool monitoring,” Sensors, vol. 20, no. 11, p. 3099, 2020.
[22] A. Steinegger, O. S. Wolfbeis, and S. M. Borisov, “Optical sensing and imaging of pH values: spectroscopies, materials, and applications,” Chemical reviews, vol. 120, no. 22, pp. 12357-12489, 2020.

1. A microfluidic system for use in liquid mixing with constant volumetric flow rates, the system comprising:
a syringe A1 which allows the reference liquid to be pumped or pushed into the microfluidic system with a constant flow rate Q1, and a syringe A2 which allows liquids to be pulled from an outlet port with a constant flow rate Q2, between which a syringe pump is positioned;
a microfluidic chip comprising a Y channel and said outlet port to combine the sample liquid and the reference liquid at atmospheric pressure Pₒ plus pressure Pₛ, which may be due to the height of the liquid; and
wherein the syringe pump allows flow Q1 to be injected into the microfluidic chip and flow Q2 to be pulled from the microfluidic chip.

2. A microfluidic system according to claim 1, comprising, when used in pH measurement:
a microfluidic chip that is used in pH measurement and comprises a Y channel to combine the sample and the pH indicator, a mixer to ensure their mixing, an observation window to pass the light from an LED light source and collect it by a colour sensor, and a LED light source that provides the necessary light for absorbance measurement;
wherein the observation window on the microfluidic chip used in pH measurement allows the light from the LED light source to pass through and be collected by the colour sensor after the point where the sample mixes with the reference liquid;
wherein the Y channel is adapted to combine the sample and pH indicator; and
a mixer for mixing the sample and pH indicator.

3. Application method of a microfluidic system providing liquid mixing with constant volumetric flow rates, comprising the process step of:
combining the volumetric flow rate of various reference chemicals with the inlet flow rate of the sample adjusted by the flow rates of the syringes used, and then taking measurements in the analysis/measurement areas and evaluating the measurements taken to find the physical, chemical, or biological property desired to be measured in the sample.

4. Application method of a microfluidic system providing liquid mixing with constant volumetric flow rates and pH measurement, comprising the process step of:
measuring the pH value as a result of mixing with the pH indicator by performing differential colorimetric measurement, in order to prevent the sample solutions from being affected by non-ideal properties such as different colours, ions, ionic strengths and temperatures and finding the pH value by evaluating the absorbance measurements before and after mixing the sample with the pH indicator taken from the observation windows.
